(19) United States
(12) Patent Application Publication
(10) Pub. No.: US 2003/0065738 A1
(43) Pub. Date: Apr. 3, 2003

(54) Wireless information systems and methods

(75) Inventors: Victor Shiang Yang, Taipei (TW); Merlie Steve Porter, Taipei (TW); Bor-Jyh Lin, Taipei (TW)

Correspondence Address: Squire, Sanders & Dempsey L.L.P., Two Renaissance Square, Suite 2700, 40 North Central Avenue, Phoenix, AZ, 85004-4498, US

(73) Assignee: Thumb Logic, Inc.

(21) Appl. No.: 10/091,829

(22) Filed: Mar. 6, 2002

Related U.S. Application Data
(60) Provisional application No. 60/326,759, filed on Oct. 1, 2001.

(51) Int. Cl. G06F 15/167

(52) U.S. Cl. 709/215

(57) ABSTRACT

An apparatus, system and method are provided for OTA downloading, configuring and updating application programs stored in a memory of mobile communication device. The apparatus and method include a number of downloadable or “built-in” application-based programs that efficiently perform the following: customizing services from various service providers via internet or call centers; downloading new applications and updating existing applications via short, wireless messages from application servers to the mobile device; notifying service providers through internet protocol between wireless application servers and service providers; uploading and registering new applications to wireless application servers from developers through the internet; and parsing short, wireless messages from messaging centers using application managers to distinguish between command messages for applications and regular text messages. The application manager, in combination with the call center and application servers, provides end-to-end data communication such that incompatible protocols are transparent to the wireless device and various service providers.

### CROSS-REFERENCE TO RELATED APPLICATIONS

This application claims the benefit of U.S. Provisional Application No. 60/326,759, filed on Oct. 1, 2001, incorporated herein by its reference.

### BACKGROUND

1. Field of the Invention

This invention relates, but not exclusively, to a wireless information processing apparatus and system capable of downloading and updating information and application programs and, more particularly to an information processing apparatus and wireless communication methods for exchanging data with a telecommunication call center utilizing short wireless messages.

2. Related Art

A significant amount of time and resources have been expended to establish systems and devices for mobile Internet access and services. Mobile Internet is all about Internet access from mobile devices. As traditional access to the Internet, e.g., home computers and businesses accessing the Internet through wired connections, has grown exponentially in recent years, Mobile Internet is projected to grow even faster. A primary factor behind this projected growth is that the force promoting and developing mobile Internet access is the cash-rich mobile phone industry. The mobile Internet already has a significant amount of Internet-based content available for mobile device users. Mobile Internet content is essentially the same as traditional Internet content but adapted for the smaller memories and displays of mobile devices. Currently, a mobile Internet website can be viewed using a mobile device that is WAP-enabled.

A mobile device is something that we take along with us where ever we go (unlike our personal computers), for example a mobile phone or a personal digital assistant. This is one of the reasons many analysts believe that within the coming few years, more people will be accessing the Internet from mobile devices than from office or home computers.

Presently, there are a variety of mobile wireless standards in existence, for which, each have different levels of data capabilities. Thanks to the developments taking place in all the 2^{nd} generation (2G) mobile wireless data technologies, and the high data speeds being promised by the 3^{rd} generation (3G) systems, the distinction between the wireless and wired Internet service providers is beginning to blur. The primary differentiation between one network and another will ultimately be the services that it provides to the end user. Data services, provided by the mobile networks are fast becoming popular and in some countries in Europe people are spending more on mobile data access than voice services. This presents a huge opportunity for the mobile data service developers.

A problem exists in development of mobile data services due to the significant variances between mobile devices and underlying wireless technologies. Typically, each mobile data service must be tailored to the specific to type of equipment and technology that will use the service. Consequently, an application developed for one manufacturer's equipment and or network provider's technology may not work for other types of equipment and technologies. This requires a standardization, which provides a generic model where applications can be written without keeping in mind the equipment and the technology.

Another problem that exists in development of mobile data services is the limitations on the equipment side. Mobile devices represent the ultimate constrained computing device with: (i) less powerful CPUs; (ii) less memory (ROM and RAM); (iii) restricted power consumption; (iv) smaller displays and (v) different input devices (e.g., a phone keypad, voice input, etc.).

Yet another problem encountered in development of mobile data services is on the network side. Wireless networks are constrained by less bandwidth, more latency, less connection stability, and less predictable availability than conventional wired networks. These inherent limitations result in significant problems for accurate and timely delivery of mobile data to mobile devices by the service.

Wireless subscribers also have a different set of essential desires and needs than those of desktop or even laptop Internet users. Mobile users, due to the inherent nature of being “on the move,” need to obtain information and data in a more efficient and timely manner than desktop or laptop users using traditional web browsers.

While the emergence of 3G technologies will improve the constraints on the low data rates for mobile devices as it is today, it must be understood that, as bandwidth increases, the handset's power consumption also increases which further taxes the already limited battery life of a mobile device. Therefore, even as wireless networks improve their ability to deliver higher bandwidth, the power availability of the mobile device will still limit the effective throughput of data to and from the mobile device. A wireless data solution must be able to overcome these network limitations and still deliver a satisfactory user experience.

One attempt at standardization for the mobile device industry is referred to as the Wireless Application Protocol (WAP). WAP is the current world standard for the presentation and delivery of wireless information and telephony services on mobile phones and other wireless terminals. The WAP Forum has published a global wireless protocol specification, based on existing Internet standards such as XML and IP, for all wireless networks. The WAP specification is developed and supported by the wireless telecommunications industry so that the entire industry and most importantly, its subscribers, can benefit from a single, open specification. WAP is designed to work with most wireless networks such as CDPD, CDMA, GSM, PDC, PHS, TDMA, FLEX, ReFLEX, iDEN, TETRA, DECT, DataTAC, Mobitex. Actually Phone.com, Ericsson, Nokia and many others, began developing standards independently of each other, but it was soon realized that it would make more sense to focus development around a common standard. WAP forum was thus born with a desire to establish a common format for Internet transfers to mobile devices, without having to customize the Internet pages for the particular display on every different mobile telephone or personal organizer.

Wireless Application Protocol (WAP) addresses most of the issues mentioned above by introducing the concept of the Internet as a wireless service platform. By addressing the constraints of a wireless environment, and adapting existing Internet technology to meet these constraints, the WAP Forum has succeeded in developing a standard that scales across a wide range of wireless devices and networks. The WAP specifications complement existing wireless standards. For example, the WAP specification does not specify how data should be transmitted over the air interface. Instead, the WAP specification is intended to sit on top of existing bearer channel standards so that any bearer standard can be used with the WAP protocols to implement complete product solutions. The WAP specification defines a protocol stack that can operate on high latency, low bandwidth networks such as Short Message Service (SMS), or GSM Unstructured Supplementary Service Data (USSD) channel. In addition to being air interface independent, the WAP specification is also independent of any particular device. Instead, it specifies the bare minimum functionality a device must have, and has been designed to accommodate any functionality above that minimum.

The WAP specification uses the best of existing standards, and has developed new extensions where needed. For example, a WAP Gateway communicates with other Internet nodes using the standard HTTP 1.1 protocol and the wireless handsets use the standard URL addressing scheme to request services.

There are other approaches to an industry standard besides WAP, including i-Mode. i-Mode is a packet-based service for mobile phones offered by NTT DoCoMo. Unlike most of the key players in the wireless arena, i-Mode eschews the Wireless Application Protocol and uses a simplified version of HTML known as Compact Wireless Markup Language (CWML) instead of WAP's Wireless Markup Language (WML).

First introduced in 1999, i-Mode was the world's first smart phone for Web browsing. The i-Mode wireless data service offers color and video over many phones. Its mobile computing service enables users to do telephone banking, make airline reservations, conduct stock transactions, send and receive e-mail, and have access to the Internet. As of early 2000, i-Mode had an estimated 5.6 million users.

However, there are many negative drawbacks associated with the WAP and i-Mode platforms for mobile Internet. A recent WAP and i-Mode usability report discusses the fact that it often takes users longer to get information from the mobile device than it does to get the information from a newspaper. The report concludes that no one will want to use WAP and i-Mode after having tried it a few times and struggled with its interface and slow connections. Simply stated, because of the difficulties involved in using these mobile Internet platforms, they will not be utilized by the average consumer. Some drawbacks of mobile Internet include: (1) excessive amount of time required to access a mobile Internet site and retrieve information; (2) poor navigational controls for browsing mobile Internet sites; and (3) poor display of information from these sites on the mobile device itself.

It should be recognized that the time spent waiting by a user for a response to a request is not necessarily the fault of WAP and i-Mode, but rather more probably results from the limited speeds available for data transfer and frequent interruptions that occur on the wireless networks.

Accordingly, it is desirable to provide information and services to users of mobile devices that do not suffer from the aforementioned problems. The following apparatuses, systems and methods alleviate one or more of the foregoing problems as described in detail below.

### SUMMARY OF THE INVENTION

The present invention discloses apparatuses, systems and methods for enabling mobile device users to obtain information and services over a wireless communications network without the users encountering the detriments, complexities and frustrations of accessing or navigating through mobile Internet websites.

A wireless information processing apparatus according to one aspect of the invention includes “built-in” application-based programs. The built-in application-based programs eliminate waiting for responses to requests through a network as opposed to web-based programs. The apparatus might therefore only link to a network in order to update the application-based programs or to exchange data that may be required for interactive services such as confirmation of booking or the like. The apparatus may thus retrieve only limited specified content or data from service providers as opposed to an entire web page.

A further aspect of the wireless information processing apparatus includes an application program manager that controls updating and downloading of application-based programs. The application program manager is a software module that is stored in and executed by the wireless information processing apparatus to manage the application-based programs and direct storage and execution of incoming and outgoing information relating to the application-based programs.

In another aspect of the invention, the wireless information processing apparatus and system may update data content for application-based programs stored in the apparatus and/or retrieve and store new or updated application-based programs using embedded commands in short wireless messages.

Yet another aspect of the invention includes a method, system and wireless information processing apparatus for automatically updating existing application-based programs stored in the apparatus with information on a periodic basis without first requiring a request from a user.

A communications system according to the present invention may include at least one mobile device having an application-based program to provide information and/or services to a user thereof, a wireless communications network facilitating communication with the mobile device, and a call center for providing information pertaining to application-based programs in the mobile device via the communications network.

Another aspect of the present invention discloses systems and methods for distributing application-based programs to mobile devices over-the-air (OTA) using Hyper Text Transfer Protocol (HTTP) and File Transfer Protocol (FTP).

A further aspect of the invention discloses systems and methods for updating data used by application-based programs stored in a mobile device using-short wireless messages.

The foregoing aspects of the present invention, among other things, promote: (i) increased stability of mobile information and services; (ii) reduced time and effort expended by a user of a mobile device; and (iii) reduced network connectivity and bandwidth usage.

### BRIEF DESCRIPTION OF THE DRAWING

These and other aspects, features and advantages of the present invention will become apparent from the following detailed description of the invention in which like references numerals denote like elements and in which:

FIGS. 1a and 1b are block diagrams illustrating communications systems for OTA distribution of programs to a mobile device;

FIG. 2 is a flow diagram illustrating a method for OTA distribution of programs to a mobile device according to a preferred embodiment of the present invention;

FIG. 3 is a flow diagram illustrating a preferred method of generating a file retrieve command for requested application programs;

FIGS. 4a and 4b illustrate example command strings contained in messages for updating and downloading programs and information;

FIG. 5 is a flow diagram illustrating a method of updating and using application programs;

FIG. 6 is a flow diagram illustrating a method of uploading application programs into a file storage location;

FIG. 7 is a flow diagram of operational sequences for software stored in a mobile device according to one embodiment of the present invention;

FIGS. 8a-8d are block diagrams illustrating embodiments for systems and methods for updating application program information;

FIG. 9 illustrates an example data structure for an application program according to one embodiment of the invention; and

FIGS. 10-12 are flow diagrams illustrating methods for managing wireless messages according to one embodiment of the invention.

### DETAILED DESCRIPTION OF THE PREFERRED EMBODIMENTS

The following definitions are provided to clarify the terms used herein. As used herein, an “application program” is a software or firmware program designed for use with a mobile device to provide a user (i) information and/or (ii) services from a service provider. Examples of application programs may be programs that manage and display to a mobile user, current weather information, traffic information, stock information, local theater information, restaurant and other entertainment information, or any other information a mobile user may desire. Application programs may also facilitate interactive services for a mobile user such as reservations and purchasing options and confirmation. A “service provider” is any entity that may provide the foregoing information, services or access to a user of a mobile device. A “mobile device” is any device having a processing unit which may receive information without requiring a wired connection. A “short wireless message” is a message for transporting discreet units of data or information between devices over a wireless network. For example, a short wireless message may be delivered by any existing wireless messaging services such as SMS (Short Messaging Service), EMS (Enhanced Messaging Service), MMS (Multimedia Messaging Service), Cell Broadcast, USSD (Unstructured Supplementary Service Data), or wireless Internet connection via point-to-point and point-to-omni point.

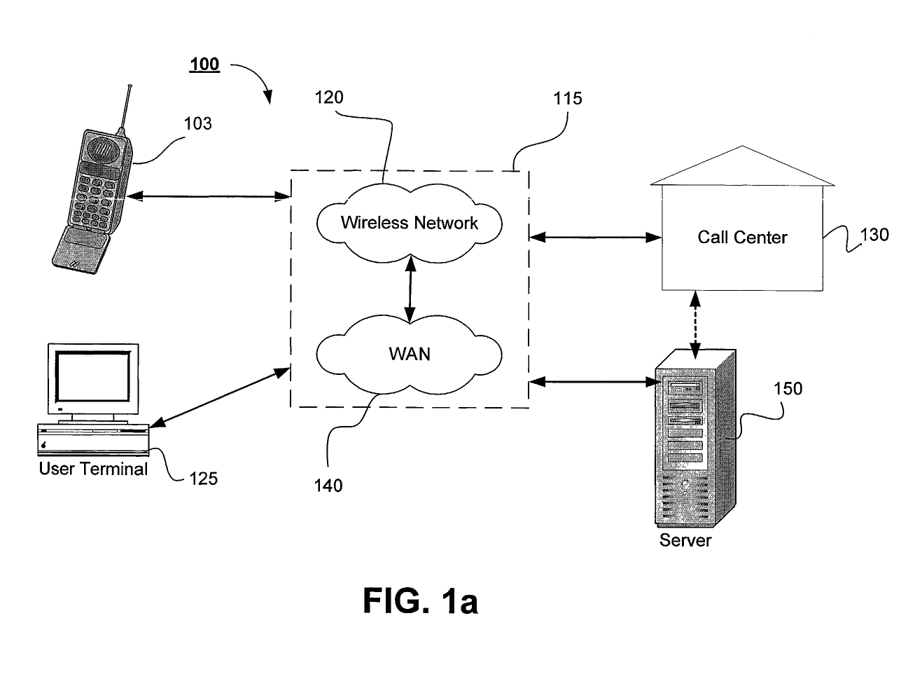

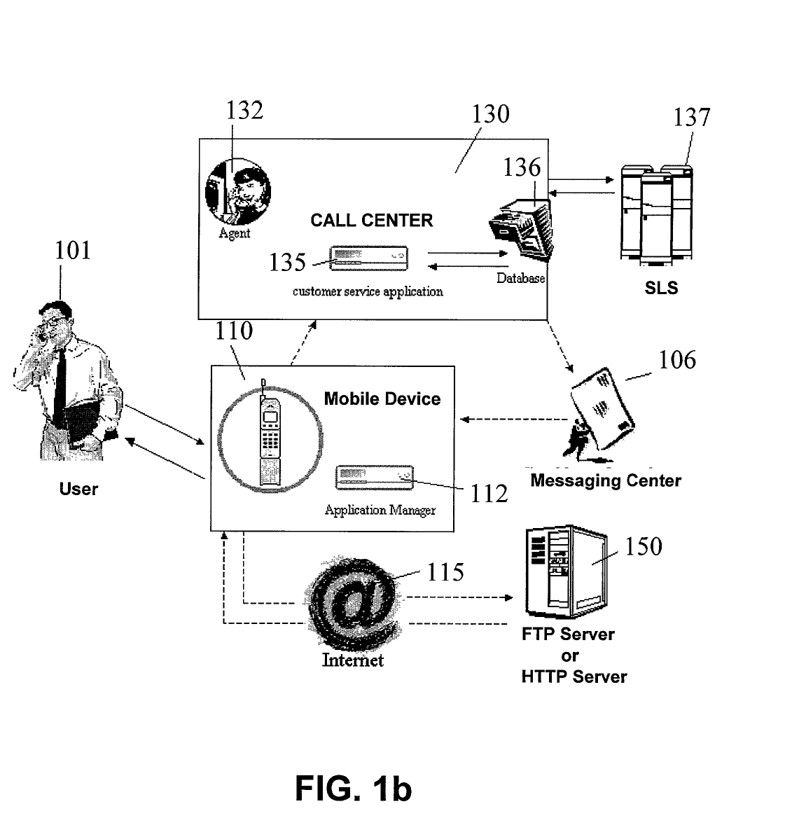

FIG. 1a illustrates a communications system 100 for OTA downloading of information to mobile devices. The system preferably includes: a mobile device 110; a communications network 11, and a call center 130. Mobile device 110 may be any device for facilitating user wireless communications including but not limited to telephones, personal digital assistants, palm top computers and other types of mobile oriented devices. In one embodiment, mobile device 110 is a wireless telephone that accommodates storage of application programs and includes one or more “built-in” application programs as discussed in further detail below. Communications network 115 may be a wireless network or any combination of wireless networks 120 and wired networks such as wide area network (WAN) 140. Call center 130 is any entity that functions to facilitate access to application programs to mobile device 110. Call center 130 preferable includes an agent 132 (FIG. 1b) that handles requests from mobile users for obtaining updated or new application programs. Agent 132 may be a person or computer that tracks stored application programs available for downloading to mobile users.

In one embodiment of the invention, application programs are stored on one or more file storage locations 150 (e.g., file server) connected to network 115. File server 150 may be local or remote to call center 130. As previously discussed, mobile device 110 preferably has a number of application programs pre-stored in a memory. A user of mobile device 110 may request new application programs for use on mobile device 110.

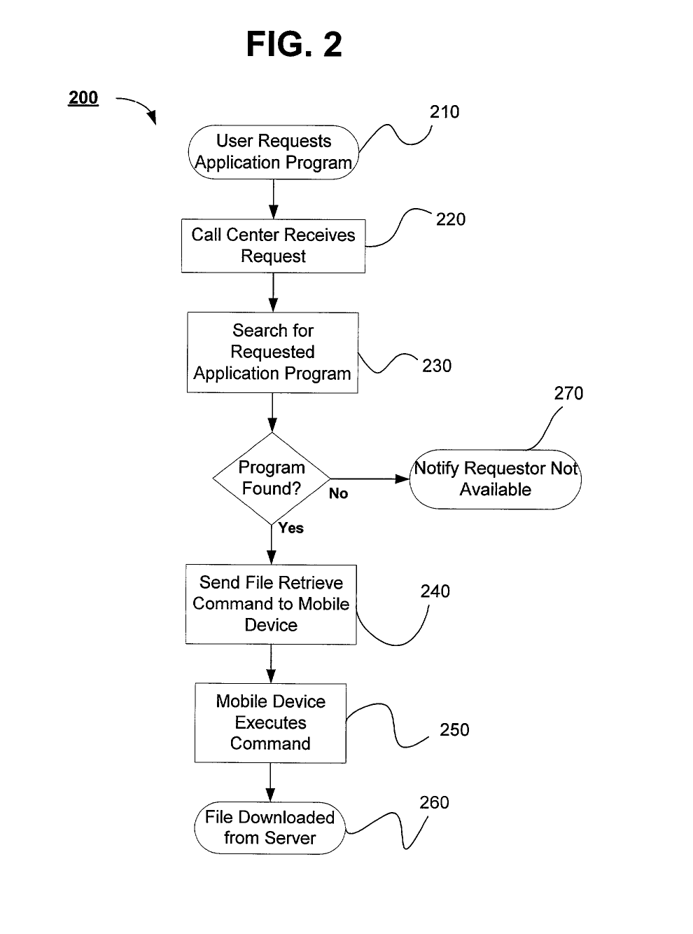

FIG. 2 illustrates a method for a call center to provide new or updated application programs 200. The method generally includes the call center: (i) receiving a request for a new or updated application program; (ii) identifying retrieval information associated with the requested application program; and (iii) sending a command to the requestor's mobile device initiating retrieval of the requested application program.

In one embodiment, a user of mobile device 110 initiates the request for new or updated application program(s) 210. To initiate the request, the user may contact the agent at the call center by any means such as voice, email or via the Internet (potentially using a separate terminal 125) to request one or more new or updated application programs. The call center receives the request 220 and searches for the requested application program(s) 230. The call center represents one or a combination of call centers that preferably, but not necessarily, offer a vocal interface with trained agents to assist users to conduct a download process or wireless device configuration. The search 230 may include searching a database or other sources to confirm the existence and location of the requested application program(s). Search 230 may also include identifying whether the requested application program already resides in a memory of the mobile device 110, but is not presently accessible by the user because it is not yet activated.

If the search confirms the existence and location of the requested application program(s), the call center sends a message to the mobile device of the requestor containing a file retrieve command 240. The mobile device executes the file retrieve command 250 which either (i) prompts file server 150 to download the application program(s) to mobile device 110 (260) or (ii) activates the application program stored in the mobile device memory. If the search does not locate the requested application program(s) the call center notifies the requestor that the requested application program is not available 270.

It should be recognized that a user is not necessarily required to request the new or updated application program as the call center or other entity may determine that an application program should be updated or replaced because, for example, the program is out of date or not applicable to the user's location. Consequently, certain steps in method 200 may be optional depending on who initiates the download of application programs.

FIG. 1b illustrates a more specific overview of a system and process for requesting and downloading application programs. Application manager 112 represents a built-in or pre-stored program for managing application programs in mobile device 110. User 101 represents a person using mobile device 110 that includes the application manager 112.

In the example of FIG. 1b, user 101 establishes a connection with the call center 130. The connection between mobile device 110 and call center 130 may be made via a wireless connection, data connection, personal visit or other communication medium. Agent 132 assists user 101 to retrieve and/or activate the requested application program. Upon request by user 101, agent 132 searches and retrieves data pertaining to the requested application program from the call center's database 136. Searching for application program data may be performed using, for example, customer service application 135, which is a program configured to search and identify locations for stored application programs.

In one embodiment, if the requested data does not exist in database 136, agent 132 may query an outside server 137 that contains additional information on location and existence of requested application programs. This server is referred to herein as Service Location Server (SLS) 137. SLS 137 is preferably an application server combined with a database server holding detailed and downloadable URL information of every registered application program available for supporting wireless device 110.

The data retrieved relating to the requested application program is preferably displayed in a well-established format such as an XML (eXtensible Markup Language) document or the like. The located data is then composed into a trigger message to trigger the mobile device 110 to download the requested application program from a file storage location, such as remote FTP server Over-The-Air (OTA) 150. In a preferred embodiment, the trigger message is a short wireless message composed from an identified XML document into a file retrieve command, e.g., File Transfer Protocol (FTP) command and embedded with the URL information into one or more short wireless messages.

The trigger message is preferably composed from the data in the XML document by customer service application 135. The trigger message, such as an SMS message, may be sent to a messaging center such as Short Messaging Service Center (SMSC) 106 for redirection and delivery to mobile device 110. SMS is a method of sending alphanumeric characters or binary data to wireless telephone users. Presently, a single short message may consist of a length up to 163 characters. SMS is a store and forward service; in other words, short messages are not necessarily sent directly from sender to recipient, but via an SMSC instead. Each wireless telephone network that supports SMS has one or more messaging centers to handle and manage the short messages.

A major advantage of SMS is that it features confirmation of message delivery. This means that, unlike paging, users do not simply send a short message on trust and hope that it gets delivered, but rather the sender of the short message is notified of delivery by receiving a received confirmation message back. Normally SMS is used only to send textual messages between users. However, in the present invention, the SMS messages contain embedded commands or data that is readable by the application manager 112 or application programs present in mobile device 110. In a preferred embodiment, the embedded commands consist of a length of command strings created by customer service application 135 during conversion of the XML document to SMS format. The embedded commands are readable and/or executed by application manager 112 to initiate download of the requested application program. In an alternate embodiment, application manager 112 composes its own file transfer command based on the file retrieve command or information in the trigger message that contains the location and filename information for the desired application program.

Application manager 112 in mobile device 110 parses the received short wireless messages for message type, specific commands and/or data. In the example above, the short wireless message includes a file retrieve command for initiating downloading of the requested application program from file server 150. In this embodiment, the file retrieve command causes the application manager 112 to create a HTTP (HyperText Transmission Protocol) or FTP (File Transfer Protocol) interface between mobile device 110 and the HTTP or FTP server 150 respectively. This may be accomplished through a wide area network 140 (“WAN”), which is preferably the Internet 115. Internet 115 is defined by the use of the Transmission Control Protocol/Internet Protocol (“TCP/IP”) to exchange information and is readily used for downloading the application programs. However, WAN 140 could be any other type of WAN or combination of networks. The connection between the FTP or the HTTP server 150 and the WAN is preferably through a high bandwidth link, for example, a T1 or T3 connection. The WAN in turn is connected to a variety of other gateways, via connections (not shown). A gateway forms a connection or bridge between the WAN and some other type of network, such as an RF wireless network, cellular network, satellite network, or other synchronous or asynchronous land-line connection. It should be recognized that system 100 is not dependent on any specific type of network and thus may be implemented using any type of network and associated communication protocols.

In the example of FIG. 1b, the FTP or HTTP server 150 sends the requested application program via Internet 115 to application manager 112 of mobile device 110. Application manager 112 categorizes the downloaded or updated application program into appropriate locations of a memory on mobile device 110. In a preferred embodiment, this memory is a removable memory device, such as a Multimedia Memory Card (MMC), Personal Computer Memory Card (PCMCIA), compact flash, smart media card, memory stick, or other interchangeable memory device that functions to store application programs for mobile device 110. A Flash-ROM (Read-Only Memory) chipset such as AMD 32MB ROM (Am29DS323D) or other types of programmable memories may be used for this purpose. In another embodiment of the present invention, the requested application program ray already be stored in the memory of mobile device 110 but invisible to the user as it is not yet activated. In this case, the trigger message from call center 130 instructs application manager 112 to activate the requested application program for user 101.

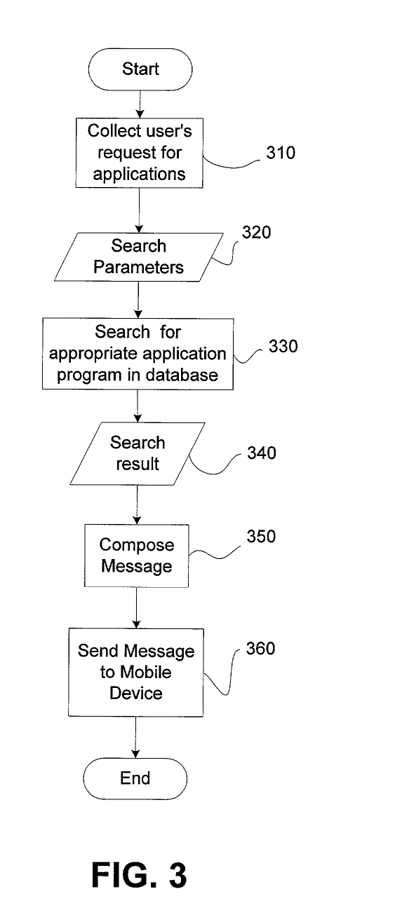

FIG. 3 is a flow chart illustrating a method for generating a file retrieve command 300. The customer service application 135 preferably operates on a server (not shown) accessible by call center 130 (FIG. 1b). Call center agent 132 receives a request from user 101 for a new or updated application program 310. Agent 132 (FIG. 1b), which may be a person or computer, formulates search parameters 320 for searching the database and performs a search using the search parameters 330. The results of the search are data retrieved in the format of an XML document or the like 340 and then converted into a trigger message 350, e.g., SMS format via customer service application 135 (FIG. 1b) and sent to the mobile device 360 via the messaging center 106 such as SMSC (Short Messaging Service Center). The mobile device then parses the received message and executes the file retrieve command in the composed message; in this case, download the requested application from server 150, e.g., an FTP or HTTP server.

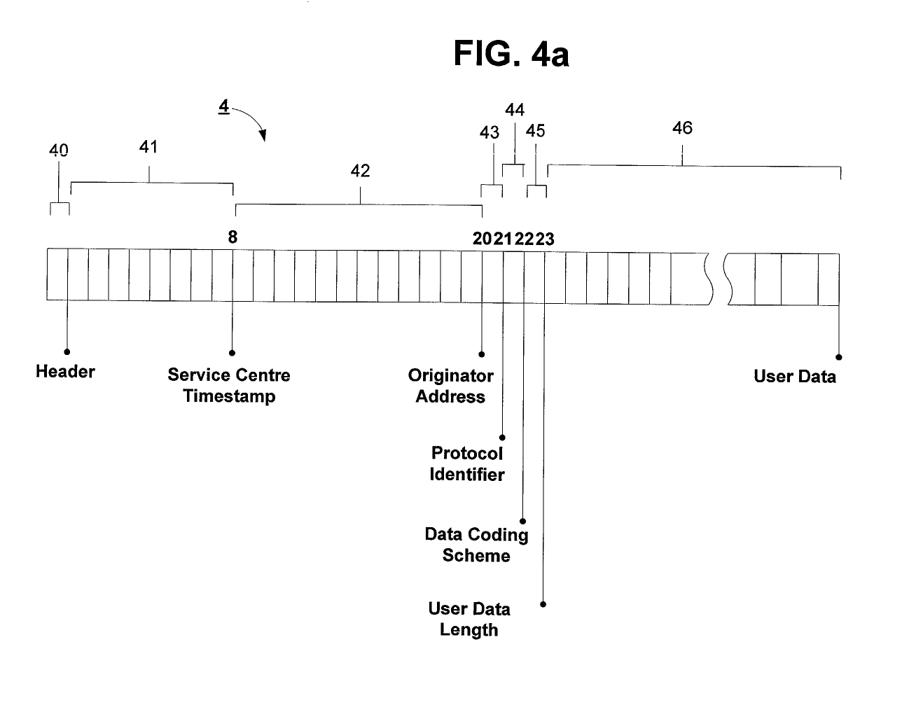

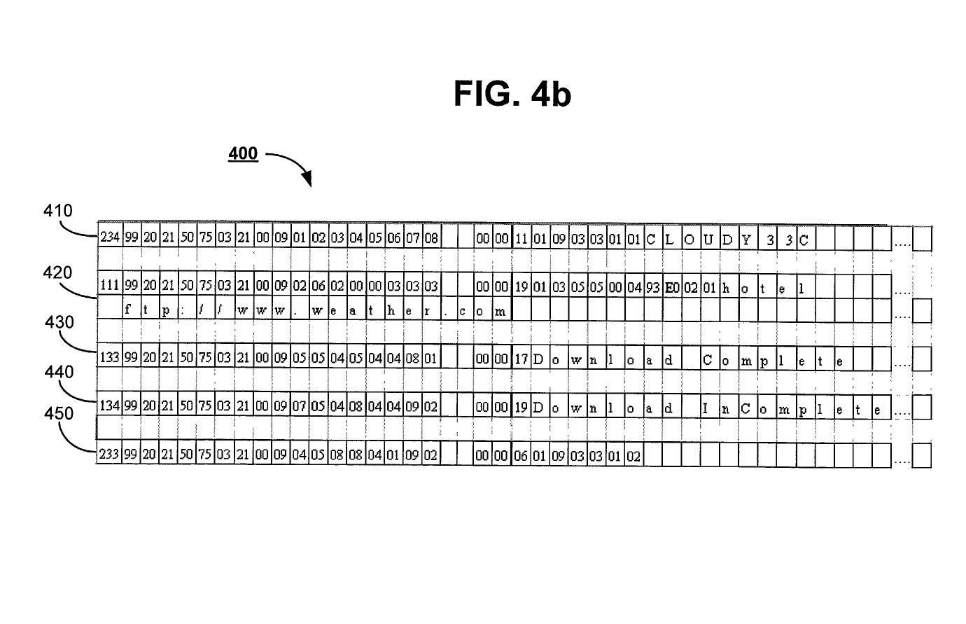

FIG. 4a illustrates an example format for a short wireless message 4 for carrying commands or data to be used by an SMS enabled mobile device according to one embodiment of the present invention. A “command” SMS message may consist of a one or more command strings readable by the application manager software residing in the mobile device (e.g., 112 of FIG. 1b). The command SMS message contains commands or data as opposed to standard “text” SMS messages. As mentioned above, a single short message can presently be up to one hundred and sixty three bytes of text in length. Therefore, in one embodiment of the invention, a command string 4 may be divided into one byte of header key and one hundred and forty bytes of content data.

Command string 4 may be divided into different sections. The header 40 uses up the 1^{st} byte, which identifies the type of message or command. Since the 1^{st} byte could contain numbers from “0” to “255,” an amount equal to two hundred and fifty six different types of SMS messages or commands may and be used. In a preferred embodiment of the invention, header 40 is a number that is not presently used in existing SMS applications. As a result, the command strings are easily differentiated from the regular SMS messages (i.e., messages that do not carry any commands or data to be used by application programs in the mobile device). The call center timestamp 41 occupies the next seven bytes of the SMS message. This call center timestamp 41 reflects the time that the message reaches the SMS Center. The timestamp 41 is displayed in the format of YYMMDDHHMMSSZZ where ZZ is the time zone. Each pair of digit (YY), or nibble, is swapped, e.g. 79=97. The time zone is in fifteen-minute units (one unit is “15” minutes) with relation to GMT (Greenwich Mean Time). For example, 0x99 0x20 0x21 0x50 0x75 0x03 0x21 means Feb. 12, 1999 05:57:30 GMT+3.

The originator address 42, or the sender's number, appropriates the next twelve bytes of the SMS message. The protocol identifier 43 occupies one byte of the SMS message and is used to determine whether the command string comprises a valid protocol. The SMS center will interpret reserved or unsupported values as the value 0 but will store them exactly as received. However, the SMS center may reject messages with a TP-Protocol-Identifier 43 containing a reserved value or unsupported value. The data-coding scheme 44 takes up one byte of the SMS message. The SMS message is encoded in either the 8 bit or 7 bit default alphabet based upon this byte. For example, having “02” instead of “00” would indicate that the TP-User-Data field of this message should be interpreted as 8 bit rather than 7 bit (this is used in e.g., smart messaging, OTA provisioning, etc). The next byte is the user data length 45, which identifies the length of the data contained in the message 4. The rest of the one hundred and forty bytes are used for the user data 46.

Each type of data may have different kinds of information in bytes depending on the type of application program using the data, which forms a stringed data structure. For instance, if the user of the mobile device requests information about a movie at a certain theatre, the data structure may comprise at least two bytes for a theatre ID number (movie theatres are preferably identified by ID numbers, not names), fourteen bytes are used for the movie title, one hundred and twelve bytes may be used for movie time (e.g., seven bytes for days, eight bytes for show times, and two bytes for movie times, 7×8×2=112), and two bytes for the price of the movie ticket. Command strings 4 may be combined in a list or combination so that more information may be conveyed to the mobile device. A list or combination of SMS command strings 4 is represented by the example illustration of FIG. 4b, which is described below. An alternative option in displaying more than one hundred and forty characters of data in one string is via compression of the bytes, for example, in PDU (protocol description unit) mode. The text mode (unavailable on some devices) is just an encoding of the bit stream represented by the PDU mode. The data may also be encrypted with algorithms such as triple-DES to ensure information security in some cases. Alphabets may differ and there are several encoding alternatives when displaying an SMS message.

FIG. 4b illustrates a list 400 of command strings generated by a web server. The first byte string 410 is an example of a web server updating a user's wireless weather application program via SMS message. The first byte, “234,” is the identification of an update command for an application program. The next seven bytes, “99202150750321,” are time stamp of the call center at Feb 12, 1999 05:57:30 GMT+3. The next ten bytes, “00090102030405060708,” are the originator's address or the sender's number (the two bytes that are left blank are not used in this case). The next two bytes, 0000, are the protocol identifier and the data-coding scheme respectively. The next byte, “11,” is the user's data length indicating the last eleven out of one hundred and forty bytes are the user's data with “01090303” representing the application program ID, “0101” representing the city ID, CLOUDY representing the cloudy weather, and 33° C. representing the temperature in Celsius.

The second byte string 420 is an example of a customer service application (e.g., 135, FIG. 1b) sending an SMS message (trigger message) to a mobile device for initiating downloading of a new application program. The first byte “111” is the identification of a download command. The next seven bytes is the time stamp of the call center. The next ten out of twelve bytes is the sender's number. The next two bytes are the protocol identifier and the data-coding scheme. The next byte “19” is the user's data length representing the last nineteen out of one hundred and forty bytes are the user's data with “01030505” representing an application program ID, “000493E0” representing the 300K file size, “02” representing a category for organizing the application program in the mobile device, “01” representing an order for which the application program will be placed in the category, the text “hotel#####” (# meaning unused bytes) representing a title of the application program, and “ftp://www.weather.com” representing the HTTP/URL of the FTP server containing the new application program for download.

The third byte string 430 is an example of an FTP server sending an SMS message to the user's wireless device to inform the user that the downloading process is complete. The first byte “133” is an identification of a completed command. The next seven bytes is the time stamp of the call center. The next ten out of twelve bytes is the sender's number. The next two bytes are the protocol identifier and the data-coding scheme. The next byte is the user's data length. The last seventeen out of one hundred and forty bytes are the user's data with the text “Download Complete” representing that the file transfer has been completed.

The fourth byte string 440 is an example of the FTP server sending an SMS message to the user's wireless device to inform the user that the downloading process is incomplete. The first byte is the identification of an incomplete command. The next seven bytes is the time stamp of the call center. The next ten out of twelve bytes is the sender's number. The next two bytes are the protocol identifier and the data-coding scheme. The next byte is the user's data length. The last nineteen out of one hundred and forty bytes are the user's data with the text “Download Incomplete” representing that the file transfer was not completed.

The fifth byte string 450 is an example of a user request for updated data in a wireless weather application program by sending an SMS message to the service provider. The wireless weather application is an example of one application program already stored in the mobile device memory. The first byte is the identification of an update command. The next seven bytes is the time stamp of the call center. The next ten out of twelve bytes is the sender's number. The next two bytes are the protocol identifier and the data-coding scheme. The next byte is the user's data length. The last six out of one hundred and forty bytes are the user's data with “01090303” being the application program ID (for the application program being updated, e.g., wireless weather application), and “0102” representing the city or requestor's location.

There are two general and non-exclusive categories of application programs that may be available to a mobile device user: (i) user interactive programs and (ii) information display programs. User interactive programs are programs that initiate communications to service providers for obtaining services or information, such as travel reservations or searching information databases. Information display programs are application programs that are configured to display a predetermined type of information to the mobile user, such as weather, news, movies, traffic updates, stock quotes, etc. Information display programs may be updated on a periodic basis without any action taken by a mobile user (i.e., information is “pushed” to the mobile device by the service provider). For example, a user may initially request that the application program for local traffic be automatically updated during morning and evening rush hours. The user's auto-update request and times are stored in a database where a computer program, e.g., customer service application 135 (FIG. 1b) or a service providers server uses this information to send SMS messages containing updates on a predetermined schedule. This enables, for example, updates to a traffic application program to be performed on a periodic basis as desired and determined by a user.

Information display programs might become interactive if a user initiates an inquiry for further information or an interactive program may merely display information if a user does not initiate some action. For example, if an application program is configured to display local theaters and current movies, show times, ticket prices, etc. associated with each theater, this information can be seamlessly updated in the mobile device, without a user even realizing such updates are occurring, since this information may only change on a weekly basis. Therefore, if a mobile user is only interested in knowing what's playing, when and where, the movie application program might be classified in the information display category, e.g., requiring no communications from the user. However, since the movie application program may also enable a mobile user to purchase tickets to a particular movie if desired, the program may also be interactive.

On the other hand certain services, for example airline reservations, are so unpredictable or situation dependent that a user may be required to provide data, e.g., dates and locations, to a service provider in order to obtain and view updated information. Consequently, the foregoing categories are not limiting to any specific application program, but rather loosely referencing categories to distinguish between application programs that typically have some initial user interaction and application programs that may not. One primary advantage of the methods, systems and devices of the present invention is to enable user's of a mobile device to have readily accessible information or “pushed data,” as opposed to prior art systems which require the user to connect to a network and find it on their own, referred to as “pulled data.” Even though the interactive application programs of the invention may, at some times, “pull data,” the manner in which this is accomplished (e.g., via the short wireless messages and/or FTP or HTTP) is far more efficient and less time consuming than the prior art mobile Internet methods.

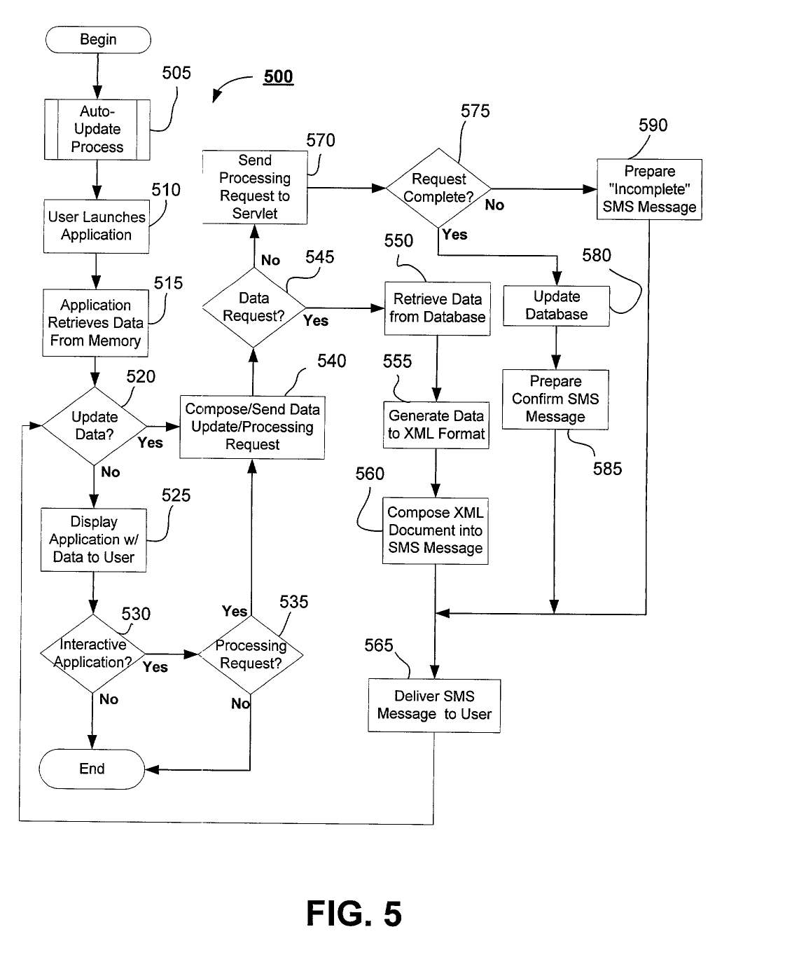

Referring to FIG. 5, a method 500 of using the mobile device and retrieving data or interacting with service providers using an application program stored in the mobile device will now be described. The service providers are typically Internet Content Providers (ICPs) that provide information or sell services to the public. The service providers may also enable a merchant with a website to build an online store on the merchant's own site or on the provider's site.

As previously discussed, the data for certain application programs may be updated automatically on a predetermined schedule 505. This does not require any interaction from the user, other than perhaps the initial selection of the frequency and times the data for each application program should be updated.

When the user of the mobile device launches one of the built-in application programs in the user's mobile device 510, the selected application program retrieves its required data from the RAM (Random Access Memory) of the mobile device 515. Launching the application program may be performed by the user selecting a desired application program from a list of available application programs displayed on a mobile device display, quick launch buttons or other method for initiating a start of a program. The launched application program may determine whether the retrieved data is out-dated or obsolete 520 based on a table or database of update values for each application program stored in memory. If the data used by the launched application program does not involve updating, for example, the data was recently updated using the auto-update process 505, then the launched application program displays a user interface including the retrieved data on a screen of the mobile device 525. At this point, if the application program is not an interactive type of program 530 or the user does not initiate a processing request 535, then the program interface and data is displayed to the user until the application program is exited or a lapse of a predetermined amount of time occurs.

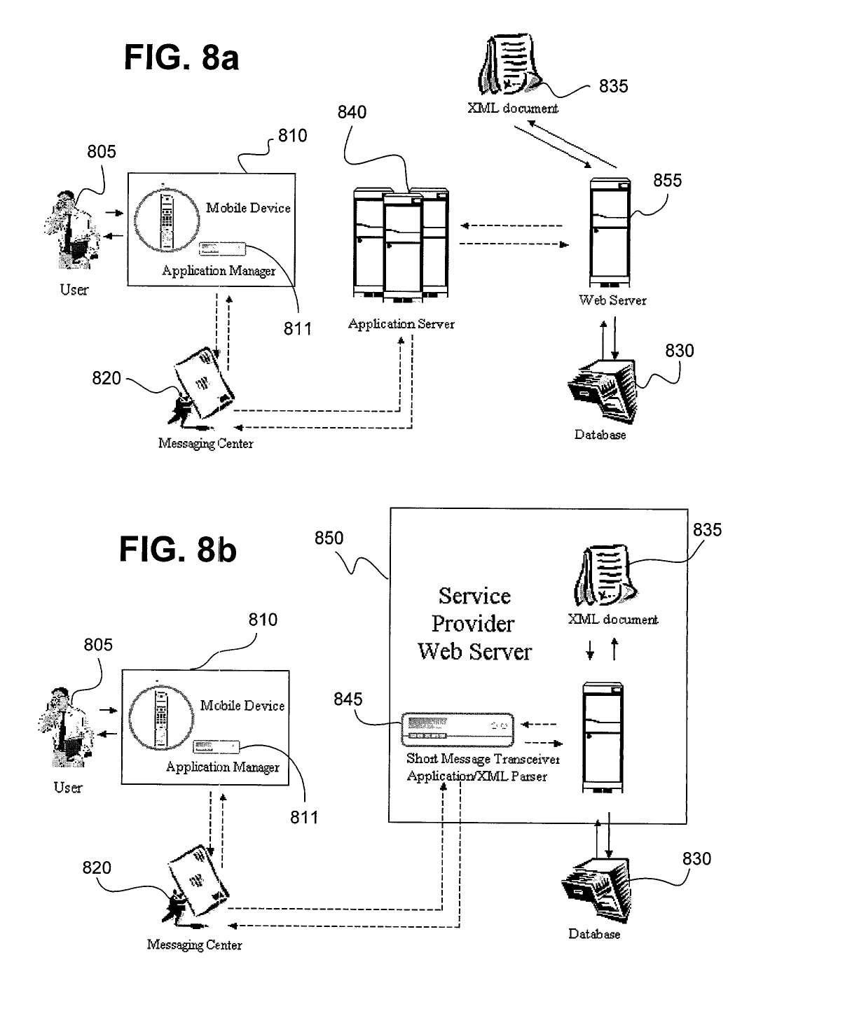

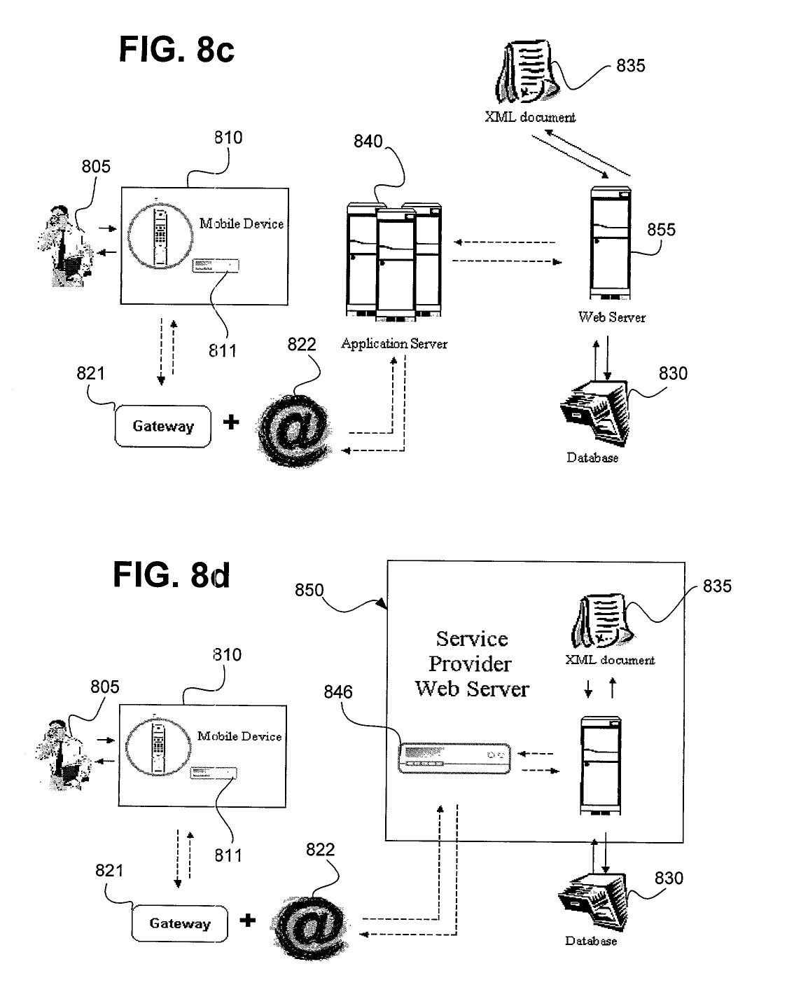

If the data does require updating 520 or the application program is an interactive type of program 530 and a user inputs a processing request 535, then a data update request or information processing request is composed by the application manager of the mobile device into one or more command string SMS messages and sent to an appropriate number depending on the type of request, the type of program and the service provider 540. This number may be different and specified for each application program. In actuality, using SMS, the message is always first sent to the SMS Center and then redirected to the appropriate application server, which either may be a separate server accessing a service providers server (805 in FIG. 8a) or a short message transceiver application hosted by a service provider (805 in FIG. 8b) for parsing and creating data update SMS messages. (FIG. 8a and FIG. 8b are system diagrams that illustrate different embodiments for a data-update process of applications programs as discussed further below.)

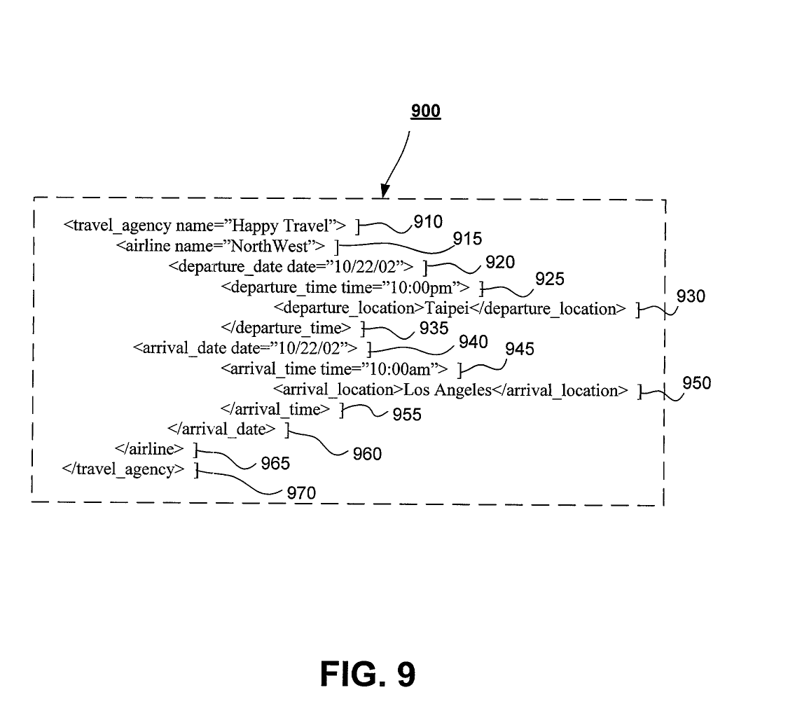

The application server determines whether the user is requesting an update of data in the database of the wireless device's application program or is submitting data for processing such as reservation/booking of any recreation events or the like 545 (this may be readily determined by the designation of the first byte 40 in each command string 4 (FIGS. 4a and 4b)). If the user requests an update of data in the database of the application program, the update request is then sent to the appropriate web server. The web server receives the request, retrieves the data update 550 and responds to the application server with an XML document containing information retrieved from database 555 for updating the data of the application program at the mobile device. The information retrieved is preferably a string of XML data type stored in database such as ORACLE. One example of the XML data type 900 is discussed further below in reference to FIG. 9.

The web server may be a combination of third-party technologies such as ORACLE 9i, JRun 3.0, Apache Xerces 1.0, and Java SDK 1.3. ORACLE 9i is the preferred database that contains the XML data document. JRun 3.0 is the preferred web engine used to run the web server. Apache Xerces 1.0 is also a third-party application used to parse XML documents to retrieve proper data using Java technology. Java SDK (Software Development Kit) 1.3 is a Java language development library used to develop programs and applications. Either the web server or application server parses the XML document with the Apache Xerces parser embedded in a Java application. The application searches a parser tree in traversal mode to get the proper data and put each data in the command string as shown in FIG. 4b. The application then composes the string into a short message 560, and sends the message to the mobile device 565, for example, thru a messaging center, thus completing the update.

As illustrated by the example flow diagram in FIG. 5, if the user launches a submission of data for processing such as reservation/booking of any recreation events or the like 535, as opposed to being a data update request, the submitted data is then sent to service provider's web server 570. If the submission is successful 575, the web server will update the service provider's database with the submitted data 580 and send a confirmation message, such as SMS, to the user's wireless data communication device 585, thus completing the submission. If the submission is unsuccessful, the web server will prepare 590 and send a failure message to the user's wireless data communication device 565.

Optionally, it may be preferable for information/data considered as confidential, to encrypt the information (not shown) when composing a short wireless message command string 540, 560. A received short wireless message that is encrypted would then be decrypted before continuing processing (not shown).

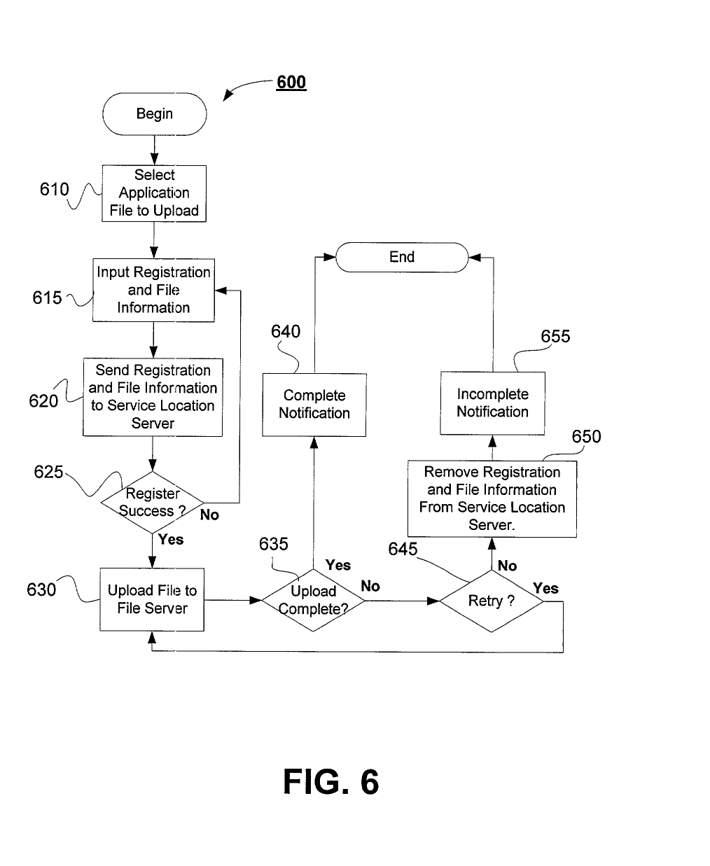

Referring to FIG. 6, a method for registering and uploading a newly developed application program 600 will now be described. As previously discussed, application programs may be downloaded and used by mobile devices. Accordingly, to increase variety and number of available services, it is preferable that service providers develop application programs for use in mobile devices. However, it is also preferable that the number and type of available application programs be tracked by a registering entity to provide consistent and accurate information to mobile device users concerning available application programs.

In the preferred embodiment application programs may be specifically tailored for each locality or city. For example, a movie application program for users in Phoenix will be tailored for the movie theaters located in Phoenix and the immediate surrounding areas. Likewise, traffic or weather application programs may be tailored to provide information specific to the areas in the locality. Any entity may develop an application program, but preferably, before a mobile device can obtain developed application programs, they are registered with a registering entity so every developed application program may be catalogued and made available to mobile users.

When an application program is developed and is ready to be deployed a developer first selects an application program to deploy 610. If the developer is already registered with the registering entity, the developer enters their registration information including preferably, the developer's digital signature, application program title and downloadable URL where the application program may be uploaded from 615. If the developer is not already registered with the registering entity, the developer may be required to obtain a registration by providing general information to the registering entity (not shown).

Preferably, before uploading an application program onto a file server (e.g., server 150; FIGS. 1a and 1b), the application program and registration information is sent to the SLS (e.g., Service Location Server 137, discussed above in reference to FIG. 1b), through Hyper Text Transfer Protocol (HTTP) 620.

If the registration is successful 625, the Service Location Server preferably responds with a success message including a temporary FTP username and password for uploading the file to the file server 630. Otherwise a failure message would be delivered and developer is returned to the registration process 615. Once the registration is completed the application program is uploaded to the file server 630. If the file upload is completed 635, the developer is notified with a completion message, e.g., “file upload complete” 640. If a problem is encountered in uploading the application program to the file server, the developer is prompted to either (i) retry or (ii) abort the uploading 645. If the developer chooses to abort uploading, the deploy procedure is incomplete and the registration and file information are deleted from the Service Location Server 650 and an incompletion message e.g., “file transfer aborted” is forwarded to the developer 655. Otherwise the file is attempted to be uploaded again 630.

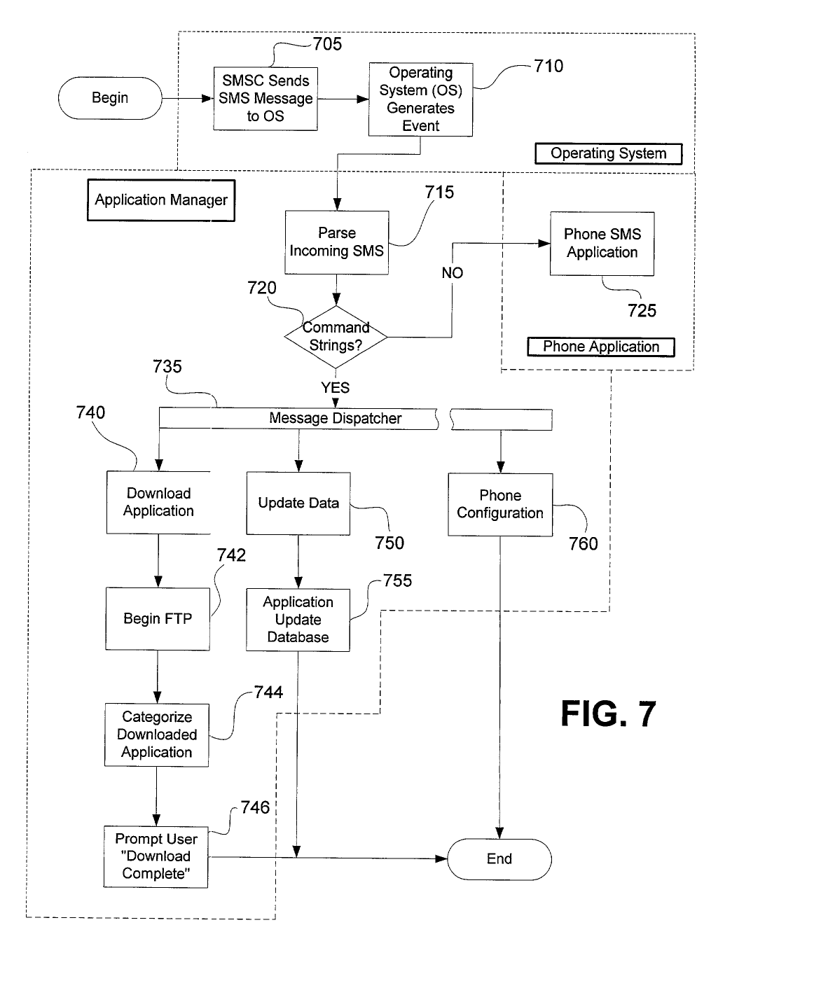

A preferred structure and function of software/firmware residing in a mobile device for receiving short wireless messages will now be described. FIG. 7 is segregated into three separate sections for improved understanding: (1) the phone application; (2) the mobile device's OS (Operating System); and (3) the application manager. The phone application represents the software/firmware designed for typical functions to operate a wireless device such as sending short wireless messages, receiving short wireless messages, call waiting, phone book, calendar, alarm clock, hand-free system, car-mode system, etc. The OS of the wireless device represents the operating system designed to handle touch-tone events, displays, and interfaces of the wireless device. The OS is preferably, though not necessarily, a custom C/C++ application that is stored in a nonvolatile mobile device memory and interfaces with the device hardware the software applications such as the application manager, or the like. The segregations described herein are only for purposes of simplified understanding as a single program or a plurality of programs may facilitate all functions of the mobile device software/firmware.

The application programs are preferably stored in Flash-ROM chipset, and are executed by the mobile device's MPU (micro processing unit) when a user selects a particular function and in response to commands from the OS. The application manager represents a built-in C/C++ software program that parses incoming short wireless messages for messages containing command strings for updates and downloads of application programs.

For incoming s sort wireless messages, a messaging center may redirect the short wireless message to the mobile device 705. The received message is then preferably queued in a block of memory also known as message queue preferably using, for example, a FIFO (First In First Out) storage/access procedure. The mobile device OS generates an event 710 instructing the application manager to parse the short wireless message 715 and determine whether the message includes commands for the application manager or not 720. If the short wireless message doesn't include commands or data for the application manager or other application programs, the application manager directs the short wireless message to the wireless device's short wireless application in the phone application 725 (e.g., an SMS message arrives with only text). If the short wireless message does include a command string, the application manager decrypts the message if necessary, and a message dispatcher in the application manager launches the appropriate command module based upon the commands detected in the parsed short wireless message 735.

The command modules may include, by way of example, a download application module 740, an update data module 750, and/or a phone configuration module 760. If the command requires downloading an application, the application manager will initiate the download application module to download an application program, preferably but not exclusively, from an FTP server via FTP protocol 742. Once the application program is downloaded, the application manager preferably categorizes and groups the application program to an appropriate section of the mobile device memory 744. The application manager may then display an interface informing the user of the completion of the downloading and categorizing process 746. If the command requires updating data 750, the application manager will replace the old data in the mobile device memory such as RAM or memory card, that corresponds to an identified application program, with data contained in the incoming short wireless message. The application manager may optionally reorganize and/or update a database for tracking application program updates 755. If the command in the parsed short wireless message requires configuration the wireless device 760, the application manager may configure the basic settings of the wireless device based upon the command parsed from the received short wireless message. Device configuration may also include activating application programs already stored in the mobile device memory but not accessible to the user.

There may be several ways for a user of a mobile device to get download service (e.g., to download new application programs, set update intervals, change data parameters for application programs, etc.). Two primary ways to get download service include: (1) contacting an agent at the call center, via voice, email or other communications, and request downloads and/or changes; and (2) go to the website of the call center (or service provider) and request downloads and/or changes.

As previously discussed a user may dial up an agent at a call center and give a rough description of his/her requirements for a new application program or request configuration or update changes to the agent who then may connect to a web server to find an application program or perform other requested changes. It is also possible for users to access a website thru the Internet, for example, by inputting keywords on the keyboard of the mobile, device or other terminal device and searching for information on desired applications. Once located, the user may push a “send” or “download” button to have the web server hosting the website send the application program information to the user's mobile device to trigger a download process. In either of the foregoing methods, the user may request changes or application programs either from the mobile device that they are using or the requests may be made from different devices such as a home computer or home telephone.

Referring to FIGS. 8a, 8b, 8c and 8d, preferred embodiments of data-update processes and systems for updating mobile device application programs will now be described. The systems disclosed in reference to FIGS. 8a and 8b may generally include mobile device 810 operated by user 805, messaging center 820 (e.g., SMSC), service provider's database 830 and generated XML documents 835 that represent retrieved data relating to an application program in XML format. The major differences between the systems in FIG. 8a and FIG. 8b is that in FIG. 8a, application server 840 is a stand-alone server whereas in FIG. 8b a “short message transceiver application/XML parser” software module 845 plays the same role as the application server 840 but operates on a Service Provider's web server 850.

Application server 840 in FIG. 8a or software module 845 in FIG. 8b represent important components in charge of: the sending and receiving of short wireless messages; composing data searching HTTP commands which may then be sent to programs operating on the Service Provider's web server 850, 855; and parsing and composing the retrieved XML information into SMS messages in a predefined application format.

In the preferred embodiment illustrated by FIG. 8a, user 805 launches a wireless application that needs to update for new information. Application manager 811 operating on the mobile device 810 generates and sends a data-update request to application server 840 via a command short wireless message, thru messaging center 820. Application manager 811 preferably includes built-in Application Program Interfaces (APIs) that are used for generating pre-composed command messages by filling in the necessary parameters such as application identification, data contents, and billing information. The generated short wireless command messages are completed and sent from mobile device 810.

The short wireless command message carrying the data-update request is parsed and composed into an HTTP request within application server 840. The HTTP request is then sent to web server 855 through, for example, a Wide Area Network (not shown). Web server 855 receives the request and responds to the application server 840 with an XML document 835 containing information retrieved from database 830 for updating the application program data in mobile device 810. The application server 840 parses the XML document and composes it into a short message and sends the message thru messaging center 820 to mobile device 810. Application manager 811 in mobile device 810 updates and stores the new data in a manner similarly discussed with respect to FIG. 7, thus completing the data updating.

Similarly, in another embodiment discussed in reference to FIG. 8b, user 805 launches an application program that requires an update for new information. Application manager 811 operating on mobile device 810 sends a data-update request thru messaging center 820, via, for example, a command string in a short wireless message, to software application 845 operating on web server 850. The short wireless message carrying the data-update request is parsed and composed into an HTTP request by software application 845. The composed HTTP request is then used to retrieve an XML document 835 that contains information from database 830 for updating the application program at mobile device 810. Software application 845 parses the XML document and composes it into a return short wireless command message and sends the message thru messaging center 820 to mobile device 810, where application manager 811 parses the return message and stores the updated data in the appropriate location (accessed by the application program), thus completing the data updating.

The updating process discussed in reference to FIGS. 8a and 8b does not have to be initiated by the user, but rather, may be automatically initiated by any of servers 840, 850 or 855. In one embodiment, the web server retrieves an XML document 835 that contains information from database 830 for updating the application program at mobile device 810. Software application 845 or application server 840 parses the XML document and composes it into a return short wireless command message and sends the message thru messaging center 820 to mobile device 810, where application manager 811 parses the return message and stores the updated data in the appropriate location (accessed by the application program), thus completing the data updating.

Additional embodiments for data updating, discussed in reference to FIGS. 8c and 8d, are similar except that in lieu of a messaging center, a Wide Area Network (WAN) 822, such a packet-switched network, e.g., Internet, and one or more gateways 821 are utilized to accomplish the data-update process. For example, a user launches a wireless application (e.g., application program), requiring an update for new information. Application manager 811, operating on mobile device 810, sends a data update request to server 840 (FIG. 8c) or server 850 (FIG. 8d), via gateway 821 and WAN 822, using a recognized transport protocol, such as TCP/IP. The server: (i) receives the request, (ii) retrieves the information, preferably from XML document 835 as discussed above, (iii) composes the information into a short wireless command message, and (iv) sends the short wireless command message thru wireless Internet connection such as TCP/IP to mobile device 810, via WAN 822 and gateway thus completing the updating.

As with the embodiments discussed in respect to FIGS. 8a and 8b, the updating process regarding the example embodiments depicted by FIGS. 8c and 8d does not require that the user initiate an update request. Instead, any of servers 840, 850 or 855 may automatically initiate the update. In this case one or more servers: (i) retrieves the information, preferably from XML document 835 as discussed above, (ii) composes the information into a short wireless command message, and (iii) sends the short wireless command message thru wireless Internet connection such as TCP/IP to mobile device 810, via WAN 822 and gateway 821 thus completing the updating.

Referring to FIG. 9a preferred format for updating application programs will now be described. In one embodiment of the present invention an XML format 900 is stored in a database, such as an ORACLE DB, containing information for updating an application program. This example demonstrates an XML data type of flight schedule. The variables inside the tags represent the elements and attributes of the data types. For example, the travel agency element 910 specifies itself with the attribute name “Happy Travel”. The travel agency element 970 closes the description of the data type. The other tags within the travel agency tag 900, e.g., elements 915-965 provide more details for the outer scope tags.

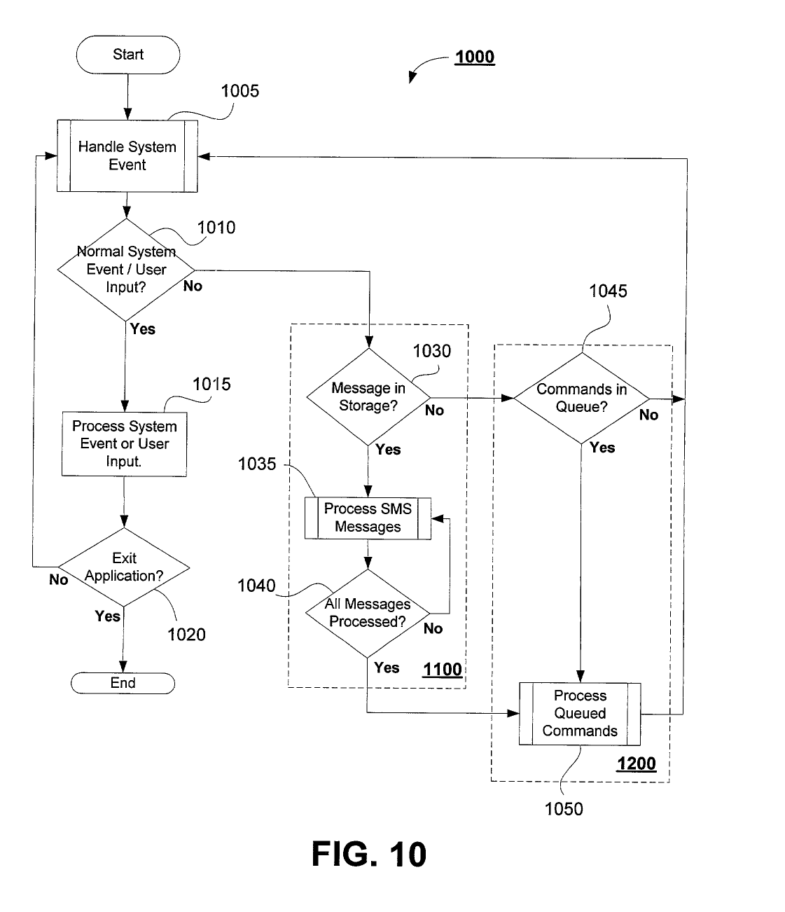

FIG. 10 illustrates a sequence diagram detailing a method 1000 for managing applications programs and received SMS messages and according to one embodiment of the present invention. As described previously, the application manager is a software or firmware application that resides on a memory of the mobile device and facilitates communications, management and control of the application programs and short wireless command messages (incoming and outgoing).

The application manager checks system events 1005 sent from the operating system that pertains to the system event 1005. If a system event occurs, the application manager checks if it is a normal system event or user input 1010. A normal system event is a system event other than arrival of a short wireless message (a message arrival event) or optionally, a generated timer event for resuming processing of messages or execution of commands.

If a normal system event occurs or a user provides an input, the system processes the normal system event or user input until completion 1015. The process returns to checking for system events 1005 unless the operating system sends an exit command to the application manager (such as shutting off the mobile device) 1020.

If the event was not a normal system event or user input, the application manager checks whether any short wireless messages are in storage 1030. If any SMS messages are stored 1030, the messages are processed 1035, e.g., parsing the SMS messages, converting the messages into commands and placing the commands in a data structure command queue of the application manager. The application manager grabs the user data section of the command string, which contains the necessary parameter for the application manager to process the command. If all messages have been processed 1040 or if no SMS messages are in storage 1030 and there are commands to be executed in the command queue 1045 the commands in the queue are processed 1050.

In one embodiment, if at any time the application manager receives a normal system event or user input, the retrieval and processing of messages and execution of commands will cease (not shown) until no further normal system events or user inputs occur. When such processing ceases or is “interrupted,” an internal timer is set to, after a predetermined amount of time, generate a timer event for resuming processing of halted or interrupted operations. This allows priority to be assigned for processing of other more essential mobile device operations and user inputs yet ensure that all messages and commands are eventually processed. The internal clock of the mobile device determines the timer's value where the timer increments with the internal clock (increment timer per internal clock ticks).

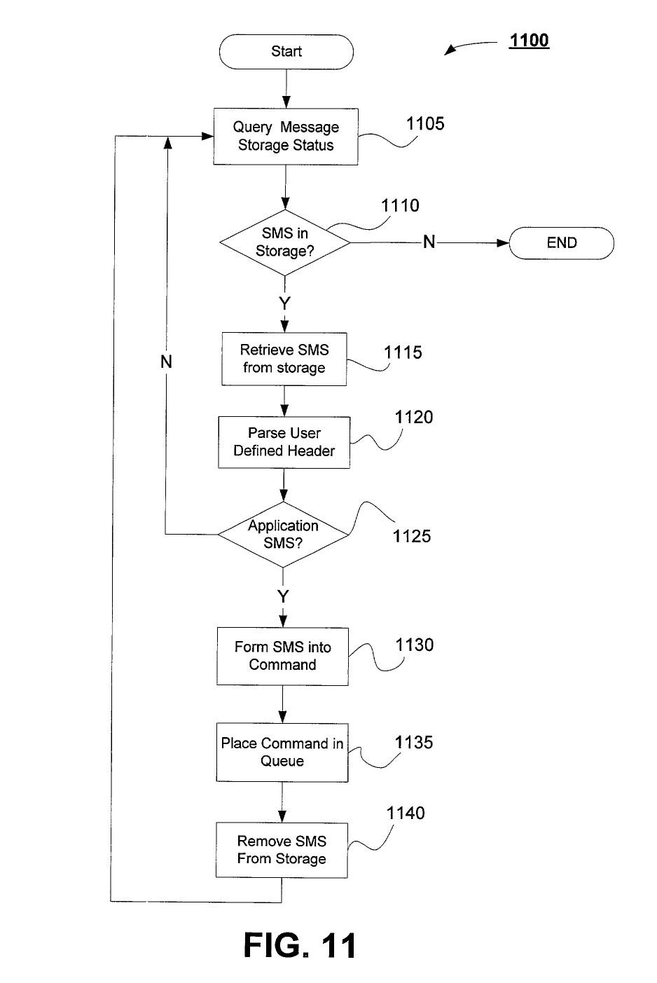

Turning to FIG. 11, a method for processing SMS messages 1100 will now be described. When SMS messages arrive to the mobile device, the messages are stored in a message storage memory such as a SIM card memory and/or device memory. The application manager checks the storage status for any stored SMS messages 1105 and if a message is found 1110, retrieves the message from memory 1115 and parses the user defined header of the message 1120 to determine whether the message is a normal text SMS message or a command SMS (containing data or commands for the application manager/application programs) 1125. As discussed in reference to FIGS. 4a and 4b above, in this embodiment of the invention, the header is the first byte of the message and can be set to a value that will indicate to the application manager that the SMS message is a command message as opposed to merely a text message.

If the retrieved message is not a command message, the application manager will check the message storage status for the next SMS message and continue on. If however, the message is a command message, the application manager will parse the message into an executable command 1130 and place the executable command in the command queue 1135 for execution.

An example command would be updating weather data content “2T1A11100000;0;20020109;2;43;34;43 ;44;High;calm; 1008;2208;”, where the definition for the string is:

“Command Type; Application identity; Packet Position; Total packet; Reserve; City; Date; Status; Hi; Low; Humidity; Rain; Radiation; Wind; Sunrise; Sunset;”

After the executable command is executed and processed, the SMS message is removed from storage, e.g., the message is deleted. Method 1100 continues until no further command SMS messages are stored in memory or, preferably as discussed in reference to FIG. 10, a system event or user input occurs.

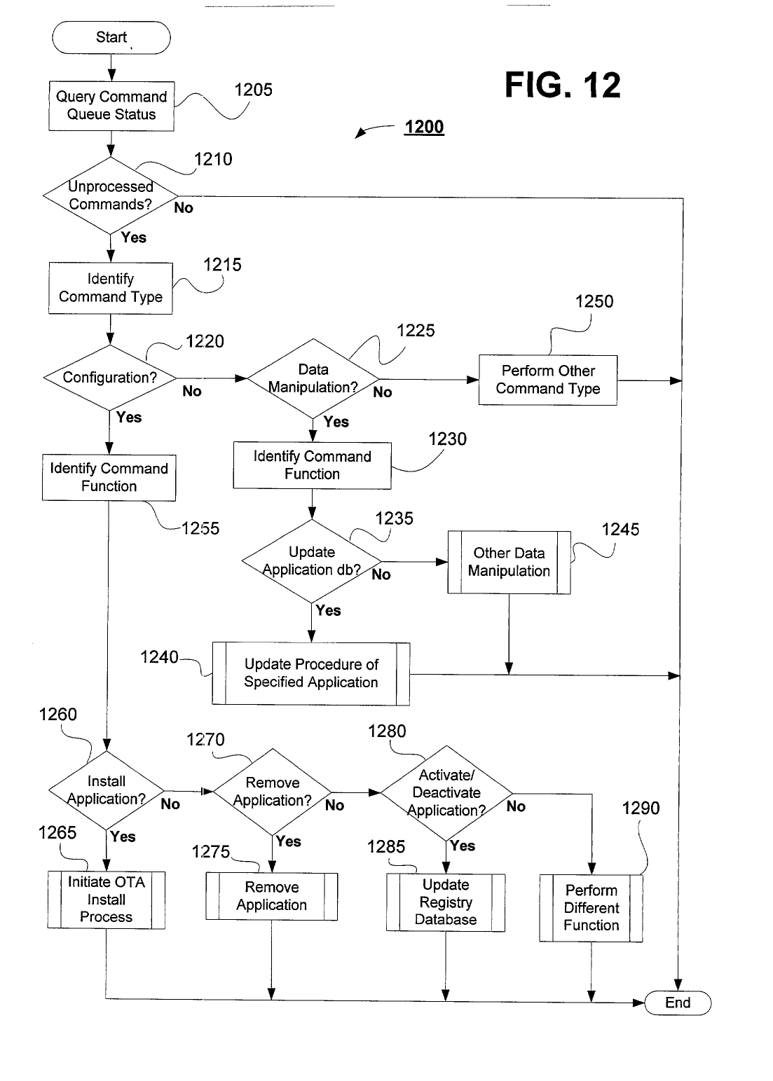

Turning to FIG. 12, a method of for processing commands in a command queue 1200 begins by querying a command queue status 1205 to determine whether there are any commands remaining to be processed 1210. If a command is found, its type is identified 1215. In a preferred embodiment of the invention there are two primary types of commands: (i) a configuration command; and (ii) a data manipulation command. A configuration command generally pertains to installing, removing, activating and deactivating application programs (e.g., 420, FIG. 4b) whereas a data manipulation command generally relates to updating and other manipulation of an application programs' database.

If the type of command is a data manipulation command 1225, the function of the command is identified (e.g., whether it is an update, reorganize, reset or other function for moving, displaying, resetting data for the application programs) 1230. If the data manipulation function pertains to updating an application program database 1235 the application manager will perform the update procedure for the specified application program 1240. If the data manipulation function is not an update, the application program will perform specified type of database manipulation 1245.

Alternatively, if the command type is a configuration command, the application manager will identify the command configuration function (e.g., whether installing, removing, or deactivating/activating application programs) 1255. If the configuration function pertains to installing an application program 1260, the application manager will initiate the Over-The-Air (OTA) process of downloading the application program (e.g., as discussed in reference to FIG. 1b). If the configuration function pertains to removing an application program 1270, the application manager performs a removal process 1275, e.g., deleting the designated application program. If the configuration function pertains to activating or deactivating one or more application programs, the application manager may, for example, update an application program registry database to reflect the active/inactive status of the designated application programs. Such registry database may be consulted by the application manager to determine what application programs may be accessed/displayed to a mobile device user.

The designations for command types and functions discussed above are discretionary and the present invention is not limited thereby. A user, based on desired function and design considerations, defines the types and functions for commands; accordingly, other command types are generally designated in FIG. 12 as “other command type” 1250 and other functions are denoted as “different function” 1290.

Unless contrary to physical possibility, the inventors envision the methods and systems described herein: (i) may be performed in any sequence and/or combination; and (ii) the components of respective embodiments combined in any manner.

Although there have been described preferred embodiments of this novel invention, many variations and modifications are possible and the embodiments described herein are not limited by the specific disclosure above, but rather should be limited only by the scope of the claims.

What is claimed is:

1. A method for over-the-air (OTA) transfer of information to a mobile device comprising:
identifying information relating to a storage location of an application program;
composing a trigger message based on the identified information;
sending the trigger message to the mobile device, the trigger message including a file retrieve command for initiating over-the-air (OTA) downloading of the application program.

2. The method of claim 1 wherein the trigger message comprises a short wireless message.

3. The method of claim 2 wherein the short wireless message comprises one of an SMS (Short Messaging Service) message, an EMS (Enhanced Messaging Service) message, an MMS (Multimedia Messaging Service) message, a Cell Broadcast message, a USSD (Unstructured Supplementary Service Data) message and a message sent through a wireless Internet connection.

4. The method of claim 1 wherein the file retrieve command comprises a File Transfer Protocol (FTP) file transfer command.

5. The method of claim 1 wherein the file retrieve command comprises a HyperText Transfer Protocol (HTTP) file transfer command.

6. The method of claim 1 wherein the storage location is identified in an eXtensible Markup Language (XML) document.

7. The method of claim 1 wherein before identifying information, the method further comprises receiving a request for the application program.

8. The method of claim 7 wherein identifying information relating to the storage location comprises searching a database for the requested application program.

9. The method of claim 1 further comprising:
receiving the trigger message, at the mobile device;
parsing the received trigger message for the file retrieve command; and
executing the file retrieve command to initiate OTA downloading of the requested application program.

10. A method for updating an application program in a mobile device, the method comprising:
identifying information to be updated in the application program;
composing a short wireless message including embedded data for updating the application program, the embedded data pertaining to the identified information; and
sending the composed short wireless message including embedded data to the mobile device.

11. The method of claim 10 wherein the embedded data comprises:
a header identifying the short wireless message as including one or more command strings; and
content data for updating the application program.

12. The method of claim 10 wherein identifying information to be updated comprises:
receiving an update request from a user of the mobile device.

13. The method of claim 10 wherein identifying information to be updated comprises:
receiving a computer generated request, wherein the computer generated request is derived from a database comprising one or more auto-update requests.

14. The method of claim 13 wherein the one or more auto-update requests comprises one or more days and times designated by a user of the mobile device.

15. The method of claim 11 wherein the content data pertains to at least one of news, traffic, weather, movie, airline and stock information.

16. A method for updating an application program in a mobile device, the method comprising:
receiving a short wireless message at the mobile device;
parsing the received message to determine whether a command string is embedded in the received message; and
storing at least a portion of the command string if embedded in the received message.

17. The method of claim 16 wherein the command string comprises:
a header portion identifying the received message as carrying a command or data update; and
a data content portion pertaining to one of a command instruction or a data field containing data for an application program.

18. The method of claim 16 wherein the short wireless message comprises one of an SMS message, an EMS message, an MMS message, a Cell Broadcast message, a USSD message, and a message sent through wireless Internet connection.

19. A short wireless message for carrying commands and data to and from a mobile device, the short wireless message comprising:
a header portion identifying the command message as containing an embedded command or data update; and
a data content portion containing at least one of instructions to be executed by a receiving device processor and a data field containing data for use by an application program.

20. The short wireless message of claim 19 wherein the command message comprises one of an SMS message, an EMS message, an MMS message, a Cell Broadcast message, a USSD message, and a message sent through a wireless Internet connection.

21. A computer program product for use with a mobile device, the computer program product including machine-readable code that, when executed by a processing device, comprises code for:
parsing a received short wireless message to determine whether any command strings exist; and
executing existing command strings for at least one of the following operations: (i) downloading an application program, (ii) activating a stored application program, and (iii) updating a database accessed by one or more application programs.

22. The computer program product of claim 21 wherein the short wireless message comprises one of an SMS message, an EMS message, an MMS message, a Cell Broadcast message, a USSD message, and a message sent through a wireless Internet connection.

23. The computer program product of claim 22 further comprising code for:
composing a data request message relating to one of a data update request or a processing request the data request message for requesting information from a remote server.

24. The computer program product of claim 23 wherein the data request message is in one of SMS, EMS, MMS, Cell Broadcast, USSD formats.

25. The computer program product of claim 21 further comprising code for:
managing said one or more application programs.

26. A system for providing information to a mobile device, the system comprising:
an apparatus operative to compose a wireless command message based on information in a document, the command message for use by a computer software application residing in a memory of the mobile device; and
a storage location accessible by the apparatus, the storage location operative to store the document.

27. The system of claim 26 wherein the wireless command message comprises one of an SMS message, an EMS message, an MMS message, a Cell Broadcast message, a USSD message, and a message sent through a wireless Internet connection, and having embedded therein, information for use by the computer software application residing on the mobile device.

28. The system of claim 26 wherein the document comprises and extensible Markup Language (XML) document.

29. The system of claim 26 wherein the apparatus comprises an application server.

30. The system of claim 26 wherein the apparatus comprises a web server including a short message transceiver application and XML parser software module.

31. The system of claim 27 wherein the computer software application comprises an application manager program.

32. The system of claim 27 wherein the computer software application comprises an application program.

33. The system of claim 27 further comprising a messaging center operative to direct the wireless command message from the apparatus to the mobile device.

34. The system of claim 33 further comprising the mobile device, wherein the application manager program is operative to extract one or more commands from the wireless command message and execute the extracted commands.

35. A method for deploying application programs developed for use by a mobile device, the application programs for providing a mobile user information and services, the method comprising:
(i) facilitating a communications connection with a user having an application program to be uploaded;
(ii) receiving registration and file information from the user;
(iii) recording the received registration and file information;
(iv) if the registration and file information is acceptable, then enabling the user to upload the application program to a networked file storage device;
(v) if the registration and file information is not acceptable, requesting the user to input the registration and file information again and return to (ii); and
(vi) if the application program was successfully uploaded, then notifying the user of the same, else requesting the user to retry uploading the application program and if so return to (iv).

36. The method of claim 35 wherein if the user does not retry uploading the application program, then deleting the recorded registration and file information.

37. The method of claim 35 wherein the registration and file information is recorded at a Service Location Server.

38. The method of claim 35 wherein the networked file storage device comprises an FTP server.

39. A mobile device including one or more memory devices, the one or more memory devices containing machine-readable code for execution by a processing unit residing in the mobile device the machine-readable code comprising:
at least one application program operative to provide information and services to a user of the mobile device; and
an application manager program operative to manage the at least one application program and operative to parse incoming short wireless messages for commands and data pertaining to the at least one application program.

40. The mobile device of claim 39 wherein the one or more memory devices comprises a multimedia memory card (MMC).

41. The mobile device of claim 39 wherein the one or more memory devices comprises a flash read only memory (ROM) chipset.

42. A method of updating information for an application program residing in a memory of a mobile device, the method comprising:
retrieving update information for updating the application program;
composing a short wireless message including the update information; and
sending the short wireless message to the mobile device over a wireless network using a transport protocol.

43. The method of claim 42 wherein the transport protocol comprises a wireless Internet protocol.

44. The method of claim 42 wherein before retrieving update information, the method further comprises:
receiving a data-update request from the mobile device.

45. The method of claim 44 wherein receiving the data-update request comprises:
completing a wireless Internet connection with the mobile device; and
receiving the data-update request using the wireless Internet connection.

46. The method of claim 42 wherein retrieving the update information comprises:
searching a server and identifying a document including the update information.

47. The method of claim 46 wherein the document comprises an XML document.

48. The method of claim 42 wherein composing the short wireless message comprises:
parsing a document; and
structuring the short wireless message based on the parsed document.

49. The method of claim 42 wherein the wireless network comprises a packet-switched network and one or more gateways.

50. The method of claim 42 wherein sending the short wireless message comprises:
sending the short wireless message over the wireless network using an HTTP transport protocol.

51. The method of claim 42 wherein sending the short wireless message comprises:
sending the short wireless message over the wireless network using an FTP transport protocol.

52. The method of claim 42 wherein sending the short wireless message comprises:
sending the short wireless message over the wireless network using a TCP/IP protocol.

53. The method of claim 43 wherein retrieving update information is initiated by a computer generated auto-update request.
